(19) United States
(12) Patent Application Publication
(10) Pub. No.: US 2009/0135677 A1
(43) Pub. Date: May 28, 2009

(54) SYSTEM AND METHOD FOR APPLICATION LAYER TIME SYNCHRONIZATION WITHOUT CREATING A TIME DISCREPANCY OR GAP IN TIME

(76) Inventor: Michel VEILLETTE, Waterloo (CA)

Correspondence Address: King and Spalding LLP (Trilliant);Trilliant Customer Number, 1700 Pennsylvania Avenue, NW, Suite 200, Washington, DC, 20006, US

(21) Appl. No.: 12/275,237

(22) Filed: Nov. 21, 2008

Related U.S. Application Data
(60) Provisional application No. 60/989,963, filed on Nov. 25, 2007.
(60) Provisional application No. 60/989,957, filed on Nov. 25, 2007.
(60) Provisional application No. 60/989,967, filed on Nov. 25, 2007.
(60) Provisional application No. 60/989,958, filed on Nov. 25, 2007.
(60) Provisional application No. 60/989,964, filed on Nov. 25, 2007.
(60) Provisional application No. 60/989,950, filed on Nov. 25, 2007.
(60) Provisional application No. 60/989,953, filed on Nov. 25, 2007.
(60) Provisional application No. 60/989,975, filed on Nov. 25, 2007.
(60) Provisional application No. 60/989,959, filed on Nov. 25, 2007.
(60) Provisional application No. 60/989,961, filed on Nov. 25, 2007.
(60) Provisional application No. 60/989,962, filed on Nov. 25, 2007.
(60) Provisional application No. 60/989,951, filed on Nov. 25, 2007.
(60) Provisional application No. 60/989,955, filed on Nov. 25, 2007.
(60) Provisional application No. 60/989,952, filed on Nov. 25, 2007.
(60) Provisional application No. 60/989,954, filed on Nov. 25, 2007.
(60) Provisional application No. 60/992,312, filed on Dec. 4, 2007.
(60) Provisional application No. 60/992,313, filed on Dec. 4, 2007.
(60) Provisional application No. 60/992,315, filed on Dec. 4, 2007.
(60) Provisional application No. 61/025,279, filed on Jan. 31, 2008.
(60) Provisional application No. 61/025,270, filed on Jan. 31, 2008.
(60) Provisional application No. 61/025,276, filed on Jan. 31, 2008.
(60) Provisional application No. 61/025,282, filed on Jan. 31, 2008.
(60) Provisional application No. 61/025,271, filed on Jan. 31, 2008.
(60) Provisional application No. 61/025,287, filed on Jan. 31, 2008.
(60) Provisional application No. 61/025,278, filed on Jan. 31, 2008.
(60) Provisional application No. 61/025,273, filed on Jan. 31, 2008.
(60) Provisional application No. 61/025,277, filed on Jan. 31, 2008.
(60) Provisional application No. 61/025,662, filed on Feb. 1, 2008.
(60) Provisional application No. 61/094,116, filed on Sep. 4, 2008.

(51) Int. Cl. G04C 11/02

(52) U.S. Cl. 368/47

(57) ABSTRACT

In correcting a time discrepancy, a clock may be speeded up or slowed down using an adjustment ratio. The ratio may be used to slow down or speed up the clock for an amount of time, after which the clock speed will be correct.

### CROSS-REFERENCE TO RELATED APPLICATIONS

This application claims the benefit of priority to the following United States provisional patent applications which are incorporated herein by reference in their entirety:
Ser. No. 60/989,963 entitled “System And Method For Application Layer Time Synchronization Without Creating A Time Discrepancy Or Gap In Time,” filed on Dec. 5, 2007 (Attorney Docket No. TR0006-PRO);
Ser. No. 60/989,957 entitled “Point-to-Point Communication within a Mesh Network”, filed Nov. 25, 2007 (Attorney Docket No. TR0004-PRO);
Ser. No. 60/989,967 entitled “Efficient And Compact Transport Layer And Model For An Advanced Metering Infrastructure (AMI) Network,” filed Nov. 25, 2007 (Attorney Docket No. TR0003-PRO);
Ser. No. 60/989,958 entitled “Creating And Managing A Mesh Network Including Network Association,” filed Nov. 25, 2007 (Attorney Docket No. TR0005-PRO);
Ser. No. 60/989,964 entitled “Route Optimization Within A Mesh Network,” filed Nov. 25, 2007 (Attorney Docket No. TR0007-PRO);
Ser. No. 60/989,950 entitled “Application Layer Device Agnostic Collector Utilizing ANSI C12.22,” filed Nov. 25, 2007 (Attorney Docket No. TR0009-PRO);
Ser. No. 60/989,953 entitled “System And Method For Real Time Event Report Generation Between Nodes And Head End Server In A Meter Reading Network Including From Smart And Dumb Meters,” filed Nov. 25, 2007 (Attorney Docket No. TR0010-PRO);
Ser. No. 60/989,975 entitled “System and Method for Network (Mesh) Layer And Application Layer Architecture And Processes,” filed Nov. 25, 2007 (Attorney Docket No. TR0014-PRO);
Ser. No. 60/989,959 entitled “Tree Routing Within a Mesh Network,” filed Nov. 25, 2007 (Attorney Docket No. TR0017-PRO);
Ser. No. 60/989,961 entitled “Source Routing Within a Mesh Network,” filed Nov. 25, 2007 (Attorney Docket No. TR0019-PRO);
Ser. No. 60/989,962 entitled “Creating and Managing a Mesh Network,” filed Nov. 25, 2007 (Attorney Docket No. TR0020-PRO);
Ser. No. 60/989,951 entitled “Network Node And Collector Architecture For Communicating Data And Method Of Communications,” filed Nov. 25, 2007 (Attorney Docket No. TR0021-PRO);
Ser. No. 60/989,955 entitled “System And Method For Recovering From Head End Data Loss And Data Collector Failure In An Automated Meter Reading Infrastructure,” filed Nov. 25, 2007 (Attorney Docket No. TR0022-PRO);
Ser. No. 60/989,952 entitled “System And Method For Assigning Checkpoints To A Plurality Of Network Nodes In Communication With A Device Agnostic Data Collector,” filed Nov. 25, 2007 (Attorney Docket No. TR0023-PRO);
Ser. No. 60/989,954 entitled “System And Method For Synchronizing Data In An Automated Meter Reading Infrastructure,” filed Nov. 25, 2007 (Attorney Docket No. TR0024-PRO);
Ser. No. 60/992,312 entitled “Mesh Network Broadcast,” filed Dec. 4, 2007 (Attorney Docket No. TR0027-PRO);
Ser. No. 60/992,313 entitled “Multi Tree Mesh Networks”, filed Dec. 4, 2007 (Attorney Docket No. TR0028-PRO);
Ser. No. 60/992,315 entitled “Mesh Routing Within a Mesh Network,” filed Dec. 4, 2007 (Attorney Docket No. TR0029-PRO);
Ser. No. 61/025,279 entitled “Point-to-Point Communication within a Mesh Network”, filed Jan. 31, 2008 (Attorney Docket No. TR0030-PRO);
Ser. No. 61/025,270 entitled “Application Layer Device Agnostic Collector Utilizing Standardized Utility Metering Protocol Such As ANSI C12.22,” filed Jan. 31, 2008 (Attorney Docket No. TR0031-PRO);
Ser. No. 61/025,276 entitled “System And Method For Real-Time Event Report Generation Between Nodes And Head End Server In A Meter Reading Network Including Form Smart And Dumb Meters,” filed Jan. 31, 2008 (Attorney Docket No. TR0032-PRO);
Ser. No. 61/025,282 entitled “Method And System for Creating And Managing Association And Balancing Of A Mesh Device In A Mesh Network,” filed Jan. 31, 2008 (Attorney Docket No. TR0035-PRO);
Ser. No. 61/025,271 entitled “Method And System for Creating And Managing Association And Balancing Of A Mesh Device In A Mesh Network,” filed Jan. 31, 2008 (Attorney Docket No. TR0037-PRO);
Ser. No. 61/025,287 entitled “System And Method For Operating Mesh Devices In Multi-Tree Overlapping Mesh Networks”, filed Jan. 31, 2008 (Attorney Docket No. TR0038-PRO);
Ser. No. 61/025,278 entitled “System And Method For Recovering From Head End Data Loss And Data Collector Failure In An Automated Meter Reading Infrastructure,” filed Jan. 31, 2008 (Attorney Docket No. TR0039-PRO);
Ser. No. 61/025,273 entitled “System And Method For Assigning Checkpoints to A Plurality Of Network Nodes In Communication With A Device-Agnostic Data Collector,” filed Jan. 31, 2008 (Attorney Docket No. TR0040-PRO);
Ser. No. 61/025,277 entitled “System And Method For Synchronizing Data In An Automated Meter Reading Infrastructure,” filed Jan. 31, 2008 (Attorney Docket No. TR0041-PRO);
Ser. No. 61/025,662 entitled “System And Method For Application Layer Time Synchronization Without Creating A Time Discrepancy Or Gap In Time,” filed Feb. 2, 2008 (Attorney Docket No. TR0044); and
Ser. No. 61/094,116 entitled “Message Formats and Processes for Communication Across a Mesh Network,” filed Sep. 4, 2008 (Attorney Docket No. TR0049-PRO).

This application hereby references and incorporates by reference each of the following United States patent applications filed contemporaneously herewith:
Ser. No. ______ entitled “Point-to-Point Communication within a Mesh Network”, filed Nov. 21, 2008 (Attorney Docket No. TR0004-US);
Ser. No. ______ entitled “Efficient And Compact Transport Layer And Model For An Advanced Metering Infrastructure (AMI) Network,” filed Nov. 21, 2008 (Attorney Docket No. TR0003-US);
Ser. No. ______ entitled “Communication and Message Route Optimization and Messaging in a Mesh Network,” filed Nov. 21, 2008 (Attorney Docket No. TR0007-US);
Ser. No. ______ entitled “Collector Device and System Utilizing Standardized Utility Metering Protocol,” filed Nov. 21, 2008 (Attorney Docket No. TR0009-US);
Ser. No. ______ entitled “Method and System for Creating and Managing Association and Balancing of a Mesh Device in a Mesh Network,” filed Nov. 21, 2008 (Attorney Docket No. TR0020-US); and
Ser. No. ______ entitled “System And Method For Operating Mesh Devices In Multi-Tree Overlapping Mesh Networks”, filed Nov. 21, 2008 (Attorney Docket No. TR0038-US).

### FIELD OF THE INVENTION

This invention pertains to systems, devices, and methods for providing time or clock synchronization without creating a time discrepancy or gap in time, and more particularly to systems, devices, and methods that cycle through all times so that a time-based event will not be missed or skipped when synchronizing the time or clock.

### BACKGROUND

Devices may require accurate clocks to perform functions such as recording data using time stamps. At times, clocks may become mis-synchronized. The clocks may require re-synchronization for the devices to continue to perform their function.

Devices on a network may require accurate times to communicate with other devices such as by initiating communication at appropriate times and receiving messages at appropriate times.

Re-setting a mis-synchronized clock may have adverse effects such as producing multiple data points at the same time, such as where a clock is set back in time to return the clock to proper synchronization. Additionally, setting a clock may lead to confusion as to the reason for the change in time at a target device.

At times, events such as reporting of energy used may need to be triggered in accordance with a schedule. A clock may be used to set that schedule. Where the clock is inaccurate, such triggering may be inaccurate. What is needed is a system and method for setting the clock in a gradual manner so as to provide an accurate time.

The foregoing examples of the related art and limitations related therewith are intended to be illustrative and not exclusive. Other limitations of the related art will become apparent to those of skill in the art upon a reading of the specification and a study of the drawings.

### SUMMARY

The following examples and aspects thereof are described and illustrated in conjunction with systems, tools, and methods that are meant to be exemplary and illustrative, not limiting in scope. In some of the examples, one or more of the above-described problems has been reduced or eliminated, while other examples are directed to other improvements.

In one non-limiting aspect, there may be provided a system and method for time synchronization without creating a time discrepancy or gap in time.

In another non-limiting aspect, there may be provided a system comprising: a first device including a radio transmitting a reference time, the first device is coupled to a time source having a reference time; a second device including a second clock and a second radio, the second radio adapted to receive a message including an instruction to synchronize the second clock either by speeding up or by slowing down the second clock to re synchronize the clock in accordance with the reference time by the use of a correction parameter.

In another non-limiting aspect, there may be provided a method comprising: transmitting a message requesting a reference time; receiving a message including a reference time; determining an amount of mis-synchronization; and adjusting a clock in a device for an amount of time and at a prescribed adjustment rate.

In another non-limiting aspect, there may be provided a method comprising: requesting a reference time from an external source; receiving a reference time from the external source; determining an amount of mis-synchronization between a local clock time within a device and the reference time; identifying a rate at which to adjust the local clock of the device to match the reference time so that the local clock and the reference times are synchronized; and adjusting the local clock time to synchronize to the reference time after a predetermined time period without skipping any local clock time increments while performing the re-synchronization.

In another non-limiting aspect, there may be provided a device comprising: a clock; a memory coupled to the clock for storing: a date and time; and a time adjustment ratio.

In another non-limiting aspect, there may be provided a system comprising: a device including a clock and a radio, the radio including a radio receiver adapted to receive a message from an external transmitter, the message including a reference time and an instruction to synchronize the clock, the synchronization being achieved either by speeding up or by slowing down the clock to re-synchronize the clock in accordance with the reference time by the use of a correction parameter.

In another non-limiting aspect, there may be provided a computer program stored in a computer readable form for execution in a processor and a processor coupled memory to implement a method comprising: transmitting a message requesting a reference time; receiving a message including a reference time; determining an amount of mis-synchronization; and adjusting a clock in a device for an amount of time and at a prescribed adjustment rate.

In another non-limiting aspect, there may be provided a computer program stored in a computer readable form for execution in a processor and a processor coupled memory to implement a method comprising: requesting a reference time from an external source; receiving a reference time from the external source; determining an amount of mis-synchronization between a local clock time within a device and the reference time; identifying a rate at which to adjust the local clock of the device to match the reference time so that the local clock and the reference times are synchronized; and adjusting the local clock time to synchronize to the reference time after a predetermined time period without skipping any local clock time increments while performing the re-synchronization.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts a diagram of a system including a control device and a target device.

FIG. 2 depicts a flowchart of a method for synchronizing a clock.

FIG. 3 depicts a flowchart of a method for synchronizing a clock.

FIG. 4 depicts an exemplary configuration having a plurality of devices on an Automated Metering Infrastructure (AMI) network.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

A target device may send information, such as information in the form of reports, to a control device at a configured frequency or interval. A clock may be used by each target device to control load profile recording, time stamp information and schedule communications. The clocks may be synchronized with a time source maintaining a reference time to guaranty accuracy.

A reference time may be a time that is approximately equal to exact time. Such a time may have a minute difference in time from the exact time. The reference time may be used by a device to adjust a time held by a device that is out of synchronization with the reference time. A correction parameter may be any information used to change a clock time. In a non-limiting example a correction ratio is a correction parameter.

In one non-limiting example the time synchronization may be performed without creating a time discrepancy or gap in time at the application layer level in the standard OSI layer model, but the invention or examples of the invention are not limited only to time synchronization only at the application layer.

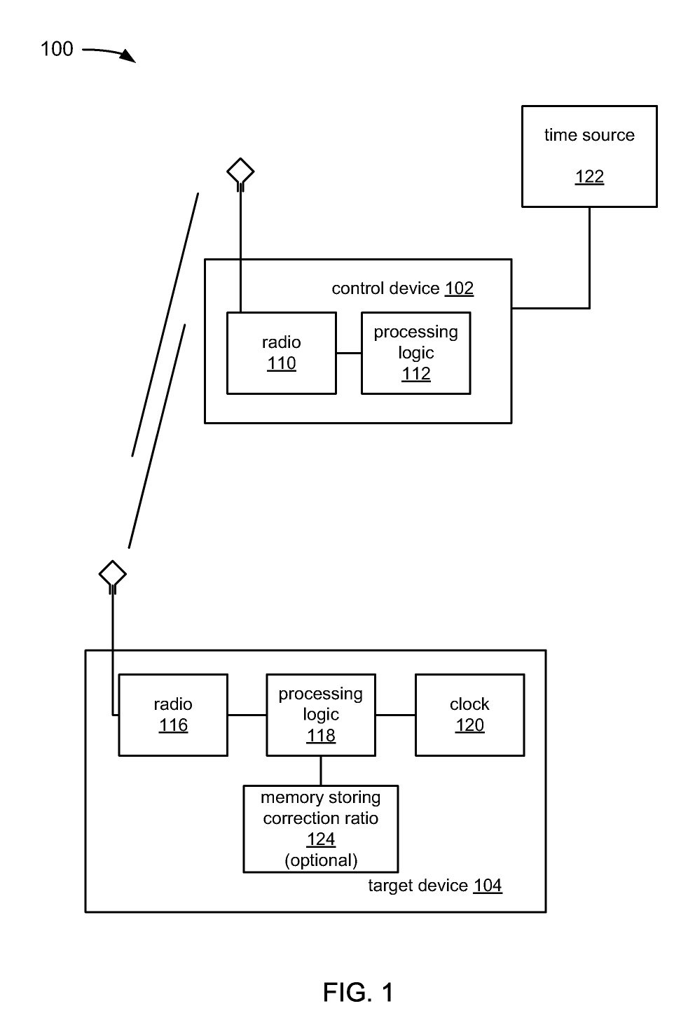

FIG. 1 depicts a diagram of a system 100 including a control device 102, a target device 104, and a time source 122 for identifying a reference time when recording energy use information. The control device 102 includes a radio 110, a processing logic unit 112. The target device 104 includes a radio 116, a processing logic unit 118, a clock 120, and optionally a memory storing a correction ratio or other correction information 124.

In the example of FIG. 1, in operation, the control device 102 transmits a message to the target device 104 requesting the time of the clock 120 of the target device 104. The target device 104 replies with the time of the clock 120. The control device 102 compares the time of the clock 120 with a time source 122 known to be reliable and determines an amount of mis-synchronization of the clock 120.

Three categories for addressing clock mis-synchronization may be established. The first is a small error, e.g. an error of less than a first predetermined or dynamically determined error threshold, such as less than 5 minutes, in which case, the clock is silently corrected. For an error greater than the predetermined or dynamically determined threshold, e.g., 5 minutes, an error is generated but the clock is re-synchronized. For mis-synchronization greater than a second predetermined or dynamically determined threshold, e.g., 15 minutes, no correction is possible, an error is generated and the clock is replaced. These thresholds are exemplary and not limiting and it will be apparent in light of the description provided here that other or different thresholds may be applied.

The time of the clock 120 may be reported at each reporting sequence; the sequence may require reporting twice a day or at any known or convenient interval. The clock 120 may be adjusted by slowing down and speeding up time of the clock 120 at the rate specified by a correction parameter. The clock 120 is slowed down or sped up so that the clock 120 will transition or count through all time values during the correction so that no time is skipped. Skipping a time may be disadvantageous as a particular time may represent a trigger for an action that is scheduled to occur, and by skipping over that time, the event would be skipped or not occur. The optional memory storing correction ratio 124 or other correction criteria or value may be used to define an amount of time for which to correct the clock. The amount of time may be specified in seconds or fractions of seconds, in counts, or in any other unit that is appropriate and convenient. In a non-limiting example a correction of “600” could mean 600 seconds or 10 minutes. Alternatively, the adjustment rate may be provided as a fraction of a % of a second. In a non-limiting example for example an adjustment rate of 40 represents an adjustment 1/40% or 21.6 seconds per day.

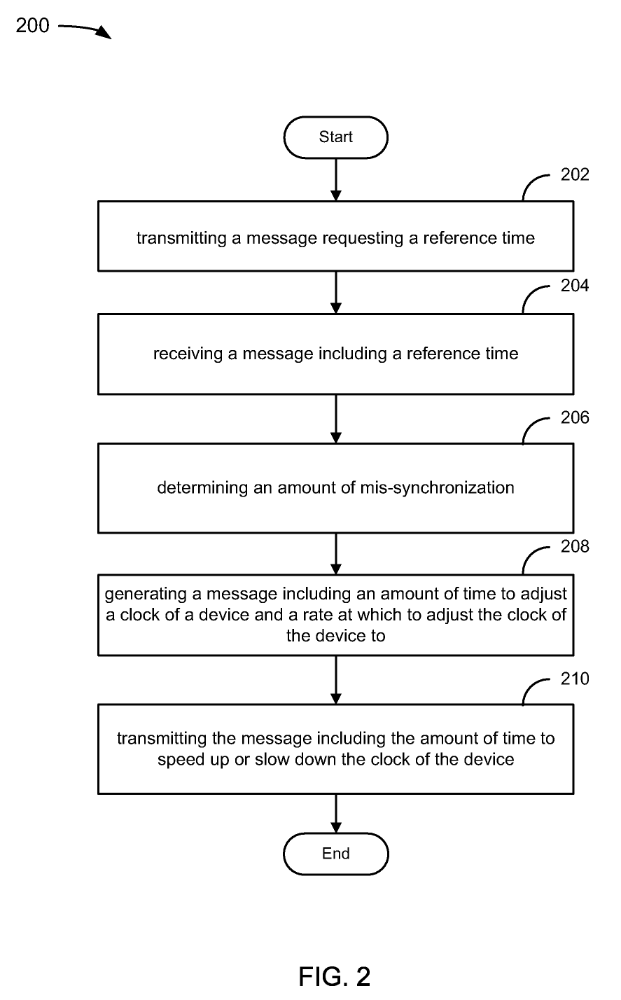

FIG. 2 depicts a flowchart of an exemplary method 200 for synchronizing a clock. The method 200 is organized as a sequence of modules or steps in the flowchart. However, it should be understood that these and modules associated with other methods described herein may be reordered for parallel execution or into different sequences of modules.

In the example of FIG. 2, the method starts at module or step 202 with transmitting a message requesting a reference time. A device may initiate the request on a regular schedule, or alternatively a user may initiate the request. At times, a head end system may cause the device to generate the request. Such a message may be transmitted by wireless (e.g., radio) or wired connection. In a non-limiting example, the transmission is accomplished by transmitting an ANSI C12.22 message.

In the example of FIG. 2, the method continues to module or step 204 with receiving a message including a reference time. Optionally, the message may be stored in local memory. In a non-limiting example, the ANSI C12.19 table format may be used to store the time. ANSI C12.22 and ANSI C12.19 may be the standards in effect as of the date of filing of this patent application, each of which standards and documents are incorporated herein by reference. The standards documents may be acquired from the National Electrical Manufacturers Association of Rossyln, Va.

In the example of FIG. 2, the method continues to module 206 with determining an amount of mis-synchronization. The amount of mis-synchronization may be indicated in seconds, minutes, or any known or convenient time measurement.

In the example of FIG. 2, the method continues to module or step 208 with generating a message including an amount of time to adjust a clock of a device and a rate (or other adjustment parameter) to which to adjust the clock of the device. The rate may be described as a fraction of a second. In a non-limiting example, the rate is n/255 seconds where the rate is specified as some value n, and is divided by 255 to produce a ratio. The ratio is the rate at which to speed up or slow down the clock. Another non-limiting example could include the adding or subtracting an amount of time from the clock so as to bring the clock into accurate time.

In the example of FIG. 2, the method continues to module or step 210 with transmitting the message including the amount of time to speed up or slow down the clock of the device. Having transmitted a message to effect re-synchronization of the clock, the method terminates.

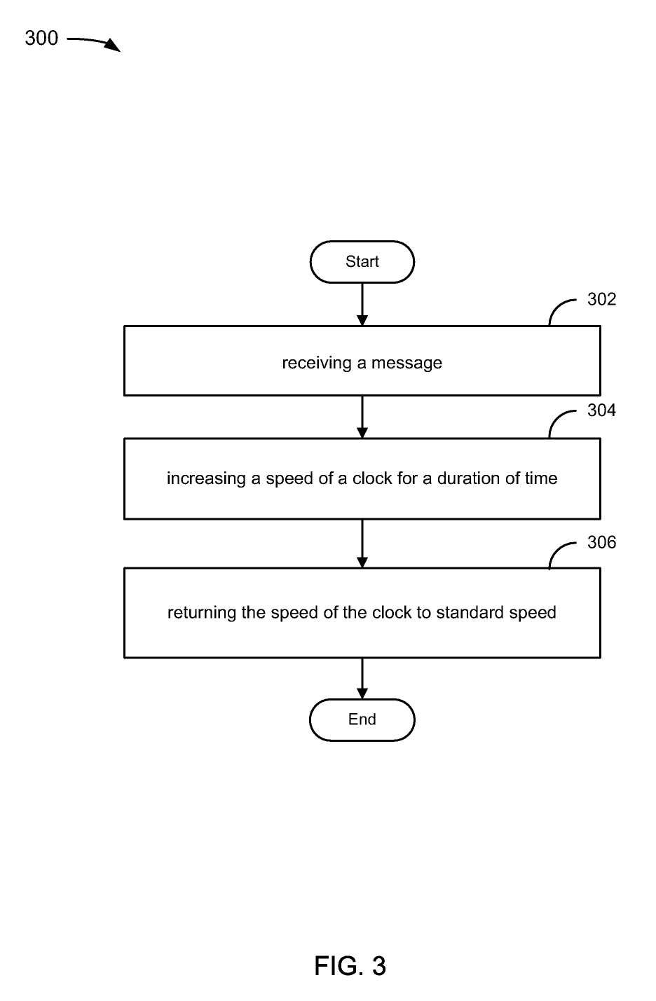

FIG. 3 depicts a flowchart of an exemplary method 300 for synchronizing a clock. The method 300 is organized as a sequence of modules or steps in the flowchart. However, it should be understood that these and modules associated with other methods described herein may be reordered for parallel execution or into different sequences of modules.

In the example of FIG. 3 the method starts at module or step 302 with receiving a message. The message may include an amount of time to speed up or slow down a clock as well as a rate to speed up or slow down the clock. Once the clock has been re-synchronized, the speed of the clock may be returned to a standard speed, where the standard speed may be a clock rate or speed that is neither speeded up nor slowed down relative to exact time. Having returned the speed of the clock to a standard speed, the method represented in the flowchart terminates.

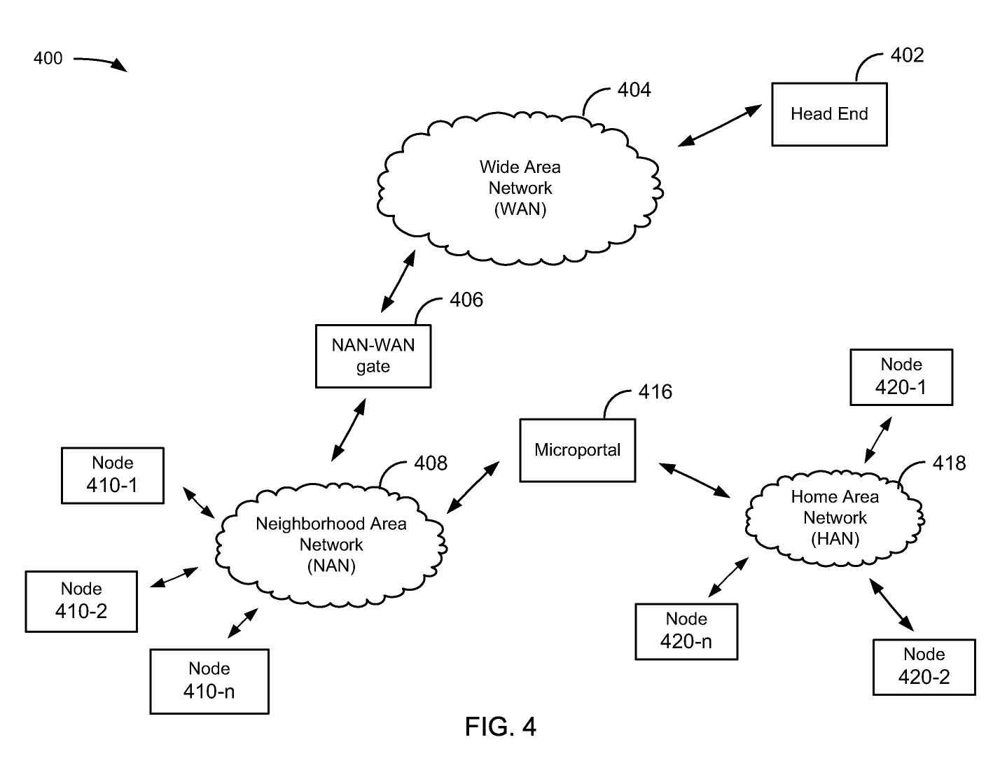

FIG. 4 depicts an exemplary configuration having a plurality of devices on an automated metering infrastructure (AMI) network 400. FIG. 4 includes head end 402, wide area network (WAN) 404, NAN-WAN gate 406, neighborhood area network (NAN) 408, node 410-1, node 410-2, node 410-n (collectively nodes 410), microportal 416, home area network (HAN) 418 (sometimes referred to as a premise area network (PAN)), node 420-1, node 420-2, node 420-n (collectively nodes 420).

The head end 402, sometimes referred to as the back end, server, or head end server can include a suite of applications including functionality for an acquisition system, real-time data access, device management, network management, and other known or convenient functionality. The head end 402 can include one or more computing devices coupled or otherwise networked together.

The WAN 404 can be, for example, metropolitan area network (MAN), global area network such as the Internet, any combination of such networks, or any other known convenient medium for communicating data. The WAN 404 can include routers, switches and/or other networking hardware elements coupled together to provide communications to systems or within systems and devices coupled to the network 404.

The NAN-WAN gate 406, sometimes referred to as a mesh gate/collector, can include an IEEE 802.15.4 PAN Coordinator, an ANSI C12.22 Relay, a device collecting messages from multiple units on the NAN and a firewall. An IEEE 802.15.4 PAN Coordinator may be a device that is responsible for communication between devices on a NAN and complies with the IEEE 802.15.4 standard for transmission of data that is in effect as of the date of filing of this patent application. An ANSI C12.22 Relay may be a device that is responsible for communication between devices on a NAN and complies with the ANSI C12.22 standard for transmission of data that is in effect as of the date of filing of this patent application. An access point operable to perform many functions including, for example, but not limited to, one or any combination of: relaying information from the head end server to the nodes, routing information, aggregating information from the nodes and micro portals within its sub-network for transmission to the head end server, acting as a HAN coordinator, transmitting mass firmware upgrades, and multicasting messages. A NAN-WAN gate 406 may also be referred to as a collector because it collects information from the nodes 410 and micro portal 416 in its sub-network.

The NAN 408, can be a wireless, wired, or mixed wireless and wired network. The NAN 408 can transmit and receive signals using a protocol, for example, the IEEE 802.15.4 standard for transmission of data that is in effect as of the date of filing of this patent application can be used for wireless transmission. Similarly for wired transmission, the Ethernet/IEEE 802.3 interface standard could be used.

The nodes 410 can be devices operable to collect metering information and transmit and receive signals via the NAN using any known or convenient protocol. Examples of nodes 410 could be a meter, a thermostat, a remote appliance controller (RAC), in home display, or any known or convenient NAN device. Each of the nodes 410 could potentially serve as a NAN-WAN gate by the addition of a WAN radio or wired device allowing communication over the WAN 404.

The microportal 416, sometimes referred to as a micro access portal or home gateway, may be a gateway in the sense that a protocol used by devices connected to the gateway use a different protocol than the gateway uses to connect to the nodes 420. In a non-limiting example, ZigBee, Z-Wave, or X-4 may be used by the nodes 420 to connect to the microportal 416 whereas the microportal 416 uses the Trilliant transport protocol to connect to the NAN-WAN gate 408.

The HAN 418 can be a wireless, wired, or mixed wireless and wired network. The NAN 408 can transmit and receive signals using a protocol. By way of example, and not limitation, the ZigBee, Z-Wave, or X-4 standard for transmission of data that is in effect as of the date of filing of this patent application can be used for wireless transmission. Similarly for wired transmission, the Ethernet/IEEE 802.3 interface standard could be used as well as other known or convenient wired interfaces.

The nodes 420 can be devices operable to collect metering information and transmit and receive signals via the HAN 418 using any known or convenient protocol. Examples of nodes 420 could be a meter, a thermostat, a remote appliance controller (RAC), in home display, or any known or convenient NAN device. Each of the nodes 410 could potentially serve as a microportal by the addition of a NAN radio or wired device allowing communication over the NAN 408. Each of the nodes 420 may include a radio and a processor coupled to a memory storing instructions. The nodes 420, may each communicate using the ZigBee protocol, the Z-Wave protocol, X-10 or another known or convenient protocol.

It will be appreciated to those skilled in the art that the preceding examples and embodiments are exemplary and not limiting in scope. It is intended that all permutations, enhancements, equivalents, and improvements thereto that are apparent to those skilled in the art upon a reading of the specification and a study of the drawings are included within the true spirit and scope of these teachings. It is therefore intended that the following appended claims include all such modifications, permutations, and equivalents as fall within the true spirit and scope of these teachings.

What is claimed is:

1. A system comprising:
a first device including a radio transmitting a reference time, the first device is coupled to a time source having a reference time;
a second device including a second clock and a second radio, the second radio adapted to receive a message including an instruction to synchronize the second clock either by speeding up or by slowing down the second clock to re-synchronize the clock in accordance with the reference time by the use of a correction parameter.

2. The system in claim 1, wherein the correction parameter comprises a correction ratio that specifies a percentage of time to speed up or slow down a clock.

3. The system in claim 1, wherein the slowing down or speeding up of the second clock to re-synchronize is performed by delaying a shorter amount of time between counts of time and without skipping any clock state or count.

4. The system of claim 1, wherein a clock has been speeded up or slowed down, and records an energy using event in accordance with the time of the clock.

5. The system of claim 1, wherein the clock is adjusted in speed in accordance to the ratio until a time discrepancy is corrected.

6. The system of claim 1, wherein the correction ratio is a percentage of 1% of the speed of the clock to speed up.

7. The system of claim 1, wherein the correction ratio is a percentage of 1% of the speed of the clock to slow down.

8. The system of claim 1, wherein the memory stores data in a format according to an ANSI C12.19 format table.

9. A method comprising:
transmitting a message requesting a reference time;
receiving a message including a reference time;
determining an amount of mis-synchronization; and
adjusting a clock in a device for an amount of time and at a prescribed adjustment rate.

10. The method of claim 9, wherein the determining an amount of mis-synchronization is performed by a device having a mis-synchronized clock.

11. The method of claim 9, wherein the generating a message including an amount of time to adjust a clock of a device and a rate at which to adjust the clock of the device to is performed by a device having the reference time.

12. The method of claim 9, wherein the rate is expressed in increments of 1/255 percent of speed (0.14 seconds per hour) to 1/1 percent of speed (36 seconds per hour).

13. The method of claim 9, wherein the rate increases the speed of the clock.

14. The method of claim 9, wherein the rate decreases the speed of the clock.

15. The method of claim 9 wherein the clock is a counter, and counts time as a total number of seconds.

16. The method of claim 9, wherein at least a portion of the method is performed at an application layer level.

17. The method of claim 9, wherein at least the steps of determining an amount of mis-synchronization and the adjusting a clock in a device for an amount of time and at a prescribed adjustment rate, are performed at an application layer level.

18. A method comprising:
requesting a reference time from an external source;
receiving a reference time from the external source;
determining an amount of mis-synchronization between a local clock time within a device and the reference time;
identifying a rate at which to adjust the local clock of the device to match the reference time so that the local clock and the reference times are synchronized; and
adjusting the local clock time to synchronize to the reference time after a predetermined time period without skipping any local clock time increments while performing the re-synchronization.

19. The method of claim 18, wherein at least a portion of the method is performed at an application layer level.

20. The method of claim 18, wherein at least the steps of determining, identifying, and the adjusting the local clock, are performed at an application layer level.

21. A device comprising:
a clock;
a memory coupled to the clock for storing:
a date and time;
a time adjustment ratio expressed in a faction of one percent (1/255-1/1).

22. The device of claim 21, wherein the clock is adjusted in speed in accordance to the ratio until a time discrepancy is corrected.

23. The device of claim 21, wherein the correction ratio is a percentage of 1% of the speed of the clock to speed up.

24. The device of claim 21, wherein the correction ratio is a percentage of 1% to slow down.

25. The device of claim 21, wherein the memory stores data in a format according to an ANSI C12.19 table.

26. The device of claim 21, further including the date, the time, and the time adjustment ratio stored in the memory.

27. A system comprising:
a device including a clock and a radio, the radio including a radio receiver adapted to receive a message from an external transmitter, the message including a reference time and an instruction to synchronize the clock, the synchronization being achieved either by speeding up or by slowing down the clock to re-synchronize the clock in accordance with the reference time by the use of a correction parameter.

28. The system in claim 27, further including the external transmitter, and wherein the external transmitter is at least intermittently coupled to a time source having the reference time.

29. A computer program stored in a computer readable form for execution in a processor and a processor coupled memory to implement a method comprising:
transmitting a message requesting a reference time;
receiving a message including a reference time;
determining an amount of mis-synchronization; and
adjusting a clock in a device for an amount of time and at a prescribed adjustment rate.

30. A computer program stored in a computer readable form for execution in a processor and a processor coupled memory to implement a method comprising:
requesting a reference time from an external source;
receiving a reference time from the external source;
determining an amount of mis-synchronization between a local clock time within a device and the reference time;
identifying a rate at which to adjust the local clock of the device to match the reference time so that the local clock and the reference times are synchronized; and
adjusting the local clock time to synchronize to the reference time after a predetermined time period without skipping any local clock time increments while performing the re-synchronization.
